(19) United States
(12) Patent Application Publication
(10) Pub. No.: US 2013/0166103 A1
(43) Pub. Date: Jun. 27, 2013

(54) AIRCRAFT EXPLORATION SYSTEM

(71) Applicant: CHUN-CHENG KO, Tu-Cheng (TW)

(72) Inventor: CHUN-CHENG KO, Tu-Cheng (TW)

(73) Assignee: HON HAI PRECISION INDUSTRY CO., LTD., Tu-Cheng (TW)

(21) Appl. No.: 13/474,967

(22) Filed: May 18, 2012

(30) Foreign Application Priority Data
Dec. 26, 2011 (TW) 100148531

(51) Int. Cl. B64C 13/20; H04R 27/00; H04N 7/18

(52) U.S. Cl. 701/2; 348/144; 381/86

(57) ABSTRACT

An aircraft exploration system includes an unmanned aircraft, a remote control, a communication processer and a data processing terminal. The an unmanned aircraft equipped with an MCU module, an image module, a first transceiver module and a GPS module, the above-mentioned modules are electronically connected to the MCU module. The unmanned aircraft is controlled by the remote control to fly. The data processing terminal is electronically connected to the communication processer, the GPS module senses the position signals of the unmanned aircraft and sends position signals to the data processing terminal, and the data processing terminal displays a map of an environment surrounding the unmanned aircraft promptly and in real time due to the positioning signals via internet.

### BACKGROUND

1. Technical Field

The present disclosure relates to an aircraft exploration system, and more particularly, to an aircraft exploration system having a capability of displaying a map on demand in real time.

2. Description of Related Art

In areas that are difficult to approach, such as a fire catastrophe or an earthquake zone, an aircraft exploration system is employed to explore and send signals back to a communication terminal. The aircraft exploration system includes an unmanned aircraft, a remote control, and a communication terminal. The unmanned aircraft is controlled by the remote control to fly. The communication terminal is employed to receive signals from the unmanned aircraft. The unmanned aircraft is equipped with a micro control unit module (MCU module), a transceiver module, and a plurality of application modules, which are electrically connected to the MCU module. The transceiver module is electrically connected to the MCU module to send signals such as video and audio collected by the MCU module back to the communication terminal via a radio frequency. However, the aircraft exploration system is unable to display a map of the environment surrounding the unmanned aircraft on demand, in real time.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is a flowchart of an embodiment of an aircraft exploration system.

FIG. 2 is an unmanned aircraft of the aircraft exploration system of FIG. 1 when taking photos in a first district A.

FIG. 3 is similar to FIG. 2, but taking photos in a second district B.

FIG. 4 is an isometric view of the unmanned aircraft of FIG. 2 viewed from a bottom.

### DETAILED DESCRIPTION

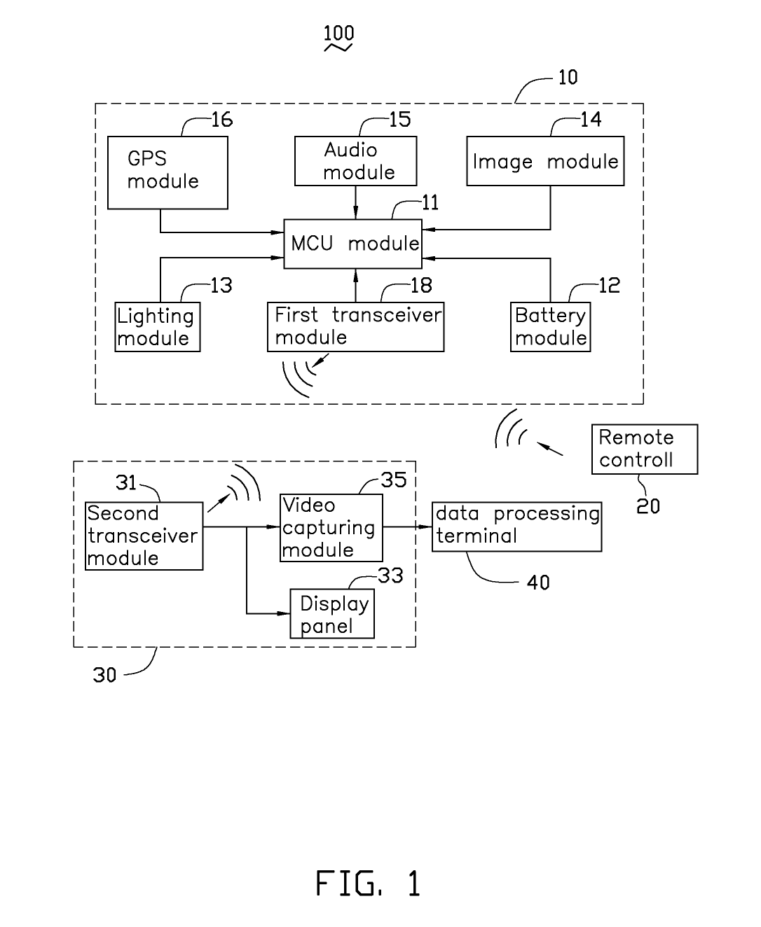

FIG. 1 shows an embodiment of an aircraft exploration system 100 including an unmanned aircraft 10, a remote control 20, a communication processer 30 and a data processing terminal 40. The unmanned aircraft 10 is controlled by the remote control 20 to fly. The unmanned aircraft 10 collects a variety of signals from an earthquake area. The communication processer 30 transmits signals to the unmanned aircraft 10, or receives signals from the unmanned aircraft 10 and transmits signals to the data processing terminal 40. The data processing terminal 40 saves the signals for post-process.

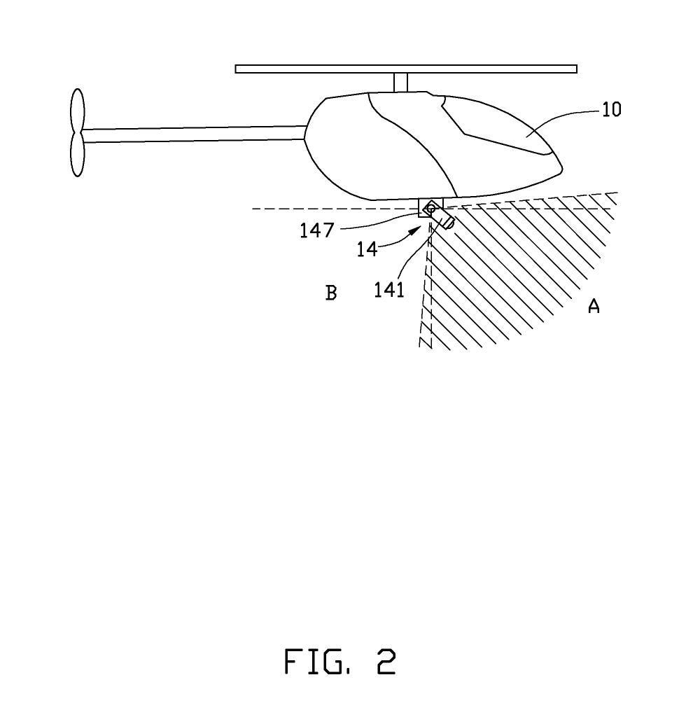

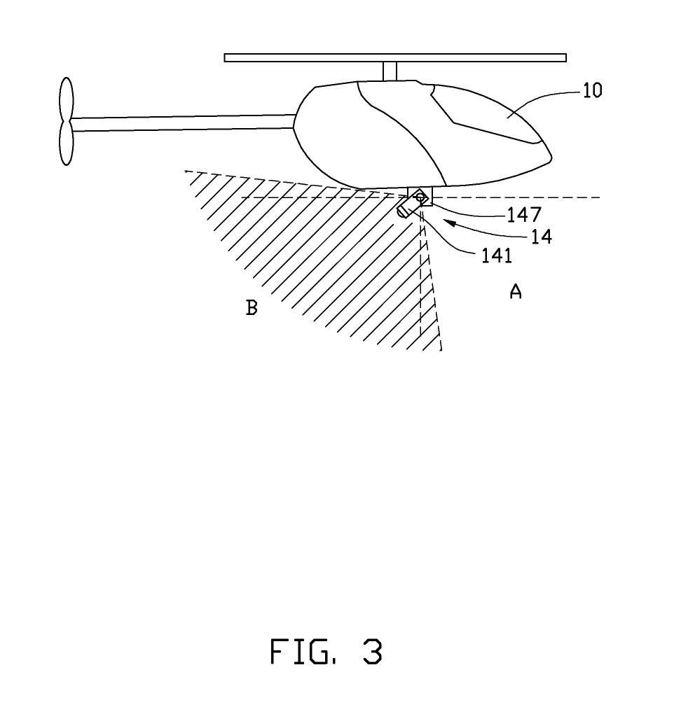

Also referring to FIGS. 2 and 3, in the embodiment, the unmanned aircraft 10 is a mini-helicopter equipped with an MCU module 11, a battery module 12, a lighting module 13, an image module 14, an audio module 15, a global positioning system (GPS) module 16 and a first transceiver module 18. The battery module 12, the lighting module 13, the image module 14, the audio module 15, the GPS module 16, and the first transceiver module 18 are electrically connected to the MCU module 11, respectively. The battery module 12 supplies power to the unmanned aircraft 10. The lighting module 13 illuminates an environment surrounding the unmanned aircraft 10. The image module 14 takes photos of the environment surrounding the unmanned aircraft 10. The audio module 15 collects sound signals surrounding the unmanned aircraft 10. The GPS position system 16 collects position signals of the unmanned aircraft 10. The MCU module 11 collects the signals from above-mentioned modules and sends it to the communication processer 30 via the first transceiver module 18. The MCU module 11 is also capable of receiving control signals from the communication processer 30 and the remote control 20 via the first transceiver module 18, to drive the above-mentioned modules to work.

The battery module 12 is mounted on the unmanned aircraft 10 and electrically connects to the MCU module 11. When the battery module 12 is exhausted, it sends a withdraw signal to the MCU module 11, then the MCU module 11 sends the withdraw signal to the communication processer 30 to warn the operator. The battery module 12 includes a plurality of lithium cells connected in series. Each lithium cell is of 11.1 volts and 2 amperes. The number of the lithium cells can be changed and determined by the flying time of the unmanned aircraft 10.

The lighting module 13 is mounted on the unmanned aircraft 10 and electrically connected to the MCU module 11. The lighting module 13 employs a sensor (not shown) to sense the luminance of the environment and sends a luminance information to the MCU module 11. The MCU module 11 controls the lighting module 13 to open due to the luminance information, thus the operator sees the unmanned aircraft 10 by the light emitting from the lighting module 13. Thus the operator controls the unmanned aircraft 10 conveniently, even when the natural light is weak. In the embodiment, the lighting module 13 employs a spotlight to emit light. In the embodiment, the lighting module 13 includes a plurality of light emitting diodes (LEDS).

A bottom of the unmanned aircraft 10 is divided into a first district A and a second district B along a flying direction of the unmanned aircraft 10. Each angular field of view of the first district A and the second district B is 90 angles. The first district A and the second district B form an angular field of view of 180 angles. The edges of the first district A and the second district B connected each other is a plane perpendicular to the flying direction of the unmanned aircraft 10.

The image module 14 is mounted on the bottom of the unmanned aircraft 10 and located on the edges where the first district A and the second district B connect to each other. The image module 14 is electrically connected to the MCU module 11 and takes photos of the first district A and the second district B. The MCU module 11 receives the photo signals and sends the signals to the communication processer 30.

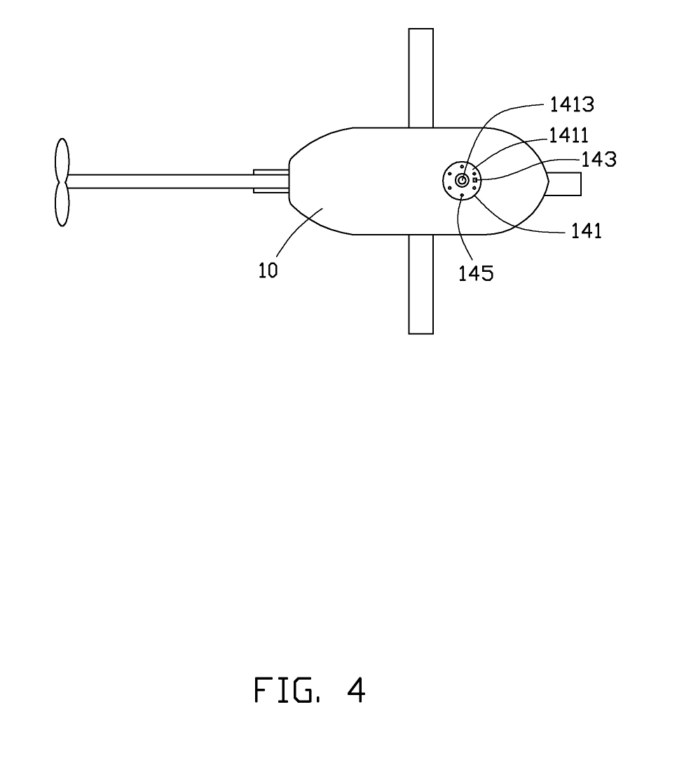

FIG. 4 shows the image module 14 including a camera 141, a light sensor 143, a plurality of infrared ray units 145 and a driving member 147 (shown in FIG. 3). The driving member 147 is mounted on the unmanned aircraft 10 and drives the camera 141 to rotate in the first district A and the second district B. The camera 141 is mounted on the driving member 147, and includes a lens case 1411 and a lens 1413. The lens case 1411 is substantially cylindrically, the lens 1413 is located in a middle of the lens case 1411. In this embodiment, the lens 1413 is a wide-angle lens, a focal-number (F-number) of the lens 1413 is no more than 1.2, a view angle of the lens 1413 is greater than 100 degrees. The light sensor 143 is mounted on a periphery of the lens case 1411 and adjacent to the lens 1413, the plurality of infrared ray units 145 is arranged around the periphery of the lens case 1411.

In the embodiment, the plurality of infrared ray units 145 are infrared LED lamps. The wavelength of the infrared ray is about 80 nanometers and the luminance distance is more than 10 meters. When the light is sufficient, the MCU module 11 controls the camera 141 to take color photos. When the light is weak, the light sensor 143 senses the weakness of the light and sends signals to the MCU module 11, then the MCU module 11 opens the plurality of infrared ray units 145. Then the camera 141 takes black-white photos with the help of the light emitted from the infrared ray units 145. In the embodiment, the driving member 147 is a two-stage motor.

FIG. 1 shows the audio module 15 is mounted on the unmanned aircraft 10 and adjacent to the image module 14. The audio module 15 is electrically connected to the MCU module 11. The audio module 15 collects sound signals in the environment surrounding the unmanned aircraft 10 and sends the sound signals to the MCU module 11, and then played in the data processing terminal 40. The audio module 15 broadcasts the sound signals transmitted from the data processing terminal 40 to enable an interaction conversation between the operator and the person near the unmanned aircraft 10.

The GPS module 16 is mounted on the unmanned aircraft 10 and is electrically connected to the MCU module 11. The GPS module 16 senses position signals such as the latitude and the longitude signals of the unmanned aircraft 10 and sends the position signals to the MCU module 11. The data processing terminal 40 receives the position signals from the MCU module 11 via the communication processer 30 and the first transceiver 18. The data processing terminal 40 displays a map of the environment surrounding the unmanned aircraft 10 promptly in real time due to the positioning signals via internet.

The first transceiver module 18 is mounted on the unmanned aircraft 10 and electrically connected to the MCU module 11. The first transceiver module 18 receives signals from or sends signals to the communication processer 30. The first transceiver module 18 employs a wireless wave whose frequency is about 2.4 GHz to transmit the signals beyond about 0.5 kilometers.

The remote control 20 is held by the operator and establishes a communication with the first transceiver module 18 to send control command to the first transceiver module 18, then the first transceiver module 18 sends control signals to the MCU module 11 to change the flying direction or tilt angle of the unmanned aircraft 10.

The communication processer 30 establishes a communication with the first transceiver module 18 to receive signals from the first transceiver module 18. The communication processer 30 processes the signals and sends the signals to the data processing terminal 40. The communication processer 30 includes a second transceiver module 31, a display panel 33, and a video capturing module 35. The display panel 33 and the video capturing module 35 are connected to the second transceiver 31. The second transceiver module 31 communicates with the first transceiver module 18. The display panel 33 receives signals from the second transceiver module 31 to display in real time. The video capturing module 35 receives analog signals from the second transceiver module 31 and converts the analog signals into digital signals, and then sends the digital signals to the data processing terminal 40 for post-processing. In the embodiment, the display panel 33 is a liquid crystal display panel.

The data processing terminal 40 is connected to the video capturing module 35 and receives digital signals from the video capturing module 35 to display or record, or save for post-processing. The data processing terminal 40 receives a position signal from the video capturing module 35 and in real time, displays a map of the environment surrounding the unmanned aircraft 10 due to the position signal via internet. The data processing terminal 40 further includes an input for receiving the voice from the operator and sending the voice to the audio module 15 via the communication processer 30, the first transceiver module 18 and the MCU module 11.

When working, the unmanned aircraft 10 is controlled by the remote control 20 to fly. The image module 14 and the audio module 15 collect photo signals and sound signals of the environment surrounding the unmanned aircraft 10, and sends the signals to the display panel 33 to display via the first transceiver module 18 and the second transceiver 30, and also sends the signals to the data processing terminal 40 for post-process. The GPS module 16 collects the position signals and sends them to the data processing terminal 40 in the same way, then the data processing terminal 40 displays a map of the environment surrounding the unmanned aircraft 10 promptly in real time, due to the position signals via internet. The operator is capable of having a conversation with the people who are near the unmanned aircraft 10 via the input of the data processing terminal 40 and the audio module 15.

The aircraft exploration system 100 includes a GPS module 16. The data processing terminal 40 displays the map of the environment surrounding the unmanned aircraft 10 promptly in real time. The image module 14 is equipped with the driving member 147, driving the cameral 141 to take photos in the first district A and the second district B. The image module 14 avoids optical distortion and fish eye phenomenon and may take photos throughout day and night. Moreover, the aircraft exploration system 100 equipped with a sets of modules in modularity to decrease the weight and the cost.

The light sensor 143 may sense the weakness of the light, and send signals to the lighting module 13 and the image module 14 synchronically. A light sensing module may be employed to send signals to the lighting module 13 and the image module 14.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An aircraft exploration system, comprising:
an unmanned aircraft equipped with an MCU module, an image module, a first transceiver module and a GPS module, wherein the image module, the first transceiver module and the GPS module are electronically connected to the MCU module;
a remote control for controlling the unmanned aircraft to fly;
a communication processer communicating with the first transceiver module for receiving signals from or sending signals to the first transceiver module; and
a data processing terminal electronically connected to the communication processer for receiving signals from or sending signals to the communication processer;
wherein the GPS module is capable of sensing position signals of latitude and longitude signals of the unmanned aircraft and sends the position signals to the MCU module, the data processing terminal receives the position signals from the MCU module via the communication processer and the first transceiver, the data processing terminal is capable of displaying a map of an environment of the unmanned aircraft opportunely and lively due to the position signals via internet.

2. The aircraft exploration system of claim 1, further comprising a battery module and a lighting module electronically connected to the MCU module, wherein the battery module is capable of supplying power to the unmanned aircraft, the lighting module is capable of illumining the environment surrounding the unmanned aircraft, when the battery module is exhausted, it sends a withdraw signal to the MCU module, then the MCU module sends the withdraw signal to the communication processer for warning.

3. The aircraft exploration system of claim 1, wherein the communication processer comprises a second transceiver module, a display panel and a video capturing module, the display panel and the video capturing module are connected to the second transceiver, the second transceiver module communicates with the first transceiver module.

4. The aircraft exploration system of claim 3, wherein the display panel is capable of receiving signals from the second transceiver module to display lively, the video capturing module receives analog signals from the second transceiver module and converts the analog signals into digital signals, then sends the digital signals to the data processing terminal for post-process.

5. The aircraft exploration system of claim 1, wherein a bottom of the unmanned aircraft is divided into a first district and a second district along a flying direction of the unmanned aircraft, the image module is electrically connected to the MCU module, the image module comprises a driving member and a camera, the driving member is capable of driving the camera rotate in the first district and the second district to take photos.

6. The aircraft exploration system of claim 5, wherein the image module further comprises a light sensor and a plurality of infrared ray units, when the light is weak, the light sensor senses the weakness of the light and sends signals to the MCU module, then the MCU module opens the plurality of infrared ray units, the camera takes black-white photos with the help of the light emitted from the infrared ray units.

7. The aircraft exploration system of claim 6, wherein a wavelength of the infrared ray of the infrared ray units is about 80 nanometers and the luminous distance thereof is further than 10 meters.

8. The aircraft exploration system of claim 6, wherein the camera comprises a lens case and a lens located in a middle of the lens case, the light sensor is mounted on a periphery of the lens case adjacent to the lens, the plurality of infrared ray units are arranged around the periphery of the lens case.

9. The aircraft exploration system of claim 8, wherein the lens is a wide-angle lens and an F-number thereof is 1.2, a view angle thereof is greater than 100 degrees, the plurality of infrared ray units are infrared LED lamps.

10. The aircraft exploration system of claim 1, further comprises a audio module mounted on the unmanned aircraft, wherein the audio module is electrically connected to the MCU module, the audio module capable of collecting sound signals in the environment of the attended aircraft and sending the sound signals to the MCU module, the sound signals is played in the data processing terminal finally, the audio module is capable of broadcasting sound signals transmitted from the data processing terminal to enable an interaction conversation between an operator and a man near the unmanned aircraft.

11. An aircraft exploration system, comprising:
an unmanned aircraft equipped with a MCU module, an image module, an audio module, a first transceiver module and a GPS module, wherein the image module, the audio module, the first transceiver module and the GPS module are electronically connected to the MCU module;
a remote control for controlling the unmanned aircraft to fly;
a communication processer communicating with the first transceiver module for receiving signals from or sending signals to the first transceiver module; and
a data processing terminal electronically connected to the communication processer for receiving signals from or sending signals to the communication processer, wherein the audio module is capable of collecting sound signals in an environment of the unmanned aircraft and sending the sound signals to the data processing terminal to display, the GPS module is capable of sensing position signals of the unmanned aircraft and sends the position signals to the MCU module, the data processing terminal receives the position signals from the MCU module via the communication processer and the first transceiver, the data processing terminal is capable of displaying a map of the environment of the unmanned aircraft opportunely and lively due to the position signals via internet.

12. The aircraft exploration system of claim 11, further comprising a battery module and a lighting module electronically connected to the MCU module, wherein the battery module is capable of supplying power to the unmanned aircraft, the lighting module is capable of illumining the environment surrounding the unmanned aircraft, when the battery module is exhausted, it sends a withdraw signal to the MCU module, then the MCU module sends the withdraw signal to the communication processer for warning.

13. The aircraft exploration system of claim 11, wherein the communication processer comprises a second transceiver module, a display panel and a video capturing module, the display panel and the video capturing module are connected to the second transceiver, the second transceiver module communicates with the first transceiver module.

14. The aircraft exploration system of claim 13, wherein the display panel is capable of receiving signals from the second transceiver module to display lively, the video capturing module receives analog signals from the second transceiver module and converts the analog signals into digital signals, then the video capturing module sends the digital signals to the data processing terminal for post-process.

15. The aircraft exploration system of claim 11, wherein a bottom of the unmanned aircraft is divided into a first district and a second district along a flying direction of the unmanned aircraft, the image module is electrically connected to the MCU module, the image module comprises a driving member and a camera, the driving member is capable of driving the camera rotate in the first district and the second district to take photos.

16. The aircraft exploration system of claim 15, wherein the image module further comprises a light sensor and a plurality of infrared ray units, when the light is weak, the light sensor senses the weakness of the light and sends signals to the MCU module, then the MCU module opens the plurality of infrared ray units, the camera takes black-white photos with the help of the light emitted from the plurality of infrared ray units.

17. The aircraft exploration system of claim 16, wherein a wavelength of the infrared ray of the infrared units is 80 nanometers and a luminance distance thereof is more than 10 meters.

18. The aircraft exploration system of claim 16, wherein the camera comprises a lens case and a lens located in a middle of the lens case, the light sensor is mounted on a periphery of the lens case adjacent to the lens, the plurality of infrared ray units are arranged around the periphery of the lens case.

19. The aircraft exploration system of claim 18, wherein the lens is a wide-angle lens and an F-number thereof is no more than 1.2, a view angle thereof is greater than 100 angles, the plurality of infrared ray units are infrared LED lamps.

20. The aircraft exploration system of claim 11, wherein the audio module is capable of broadcasting sound signals transmitted from the data processing terminal to enable an interaction conversation between an operator and a man near the unmanned aircraft.
